(19) United States
(12) Patent Application Publication
(10) Pub. No.: US 2024/0358475 A1
(43) Pub. Date: Oct. 31, 2024

(54) APPLICATION OF DENTAL CEMENT TO DENTAL RESTORATION ELEMENTS

(71) Applicant: EXOCAD GMBH, Darmstadt (DE)

(72) Inventors: Gustavo ISMAEL, Mainz (DE); Paul SCHNITZSPAN, Seeheim-Jugenheim (DE)

(21) Appl. No.: 18/139,572

(22) Filed: Apr. 26, 2023

(51) Int. Cl. A61C 5/50; A61C 5/62

(52) U.S. Cl. CPC A61C 5/50; A61C 5/62

(57) ABSTRACT

Disclosed herein is a method of applying dental cement to a concave surface of a dental restoration element. The concave surface of the dental restoration element is configured to mate with a first convex surface of a dental mounting structure such that there is a dental cement gap between the concave surface and the first convex surface. The method comprises: receiving the dental restoration element; receiving a cement applicator, wherein the cement applicator comprises a second convex surface, wherein the second convex surface is a transformation of the first convex surface such that it is shrunk by a reduction factor; applying the dental cement to the concave surface; inserting the second convex surface of the cement applicator into the concave surface of the dental restoration element; and removing the cement applicator from the dental restoration element to provide the dental restoration element with the applied dental cement.

### FIELD OF THE INVENTION

The invention relates to dental technology, in particular to dental restoration elements.

### BACKGROUND AND RELATED ART

Dental restoration elements such as crowns are typically glued to dental mounting structures using dental cement. Dental professionals such as dentists typically apply large amounts of dental cement to the dental restoration element to ensure that the dental restoration element will be adequately adhered to the dental mounting structure. The dental professional may then clean the excess dental cement from the mouth of the subject.

### SUMMARY

The invention provides for a method, a dental system, and a computer program in the independent claims. Embodiments are given in the dependent claims.

In one aspect the invention provides for a method of applying dental cement to a concave surface of a dental restoration element. The concave surface of the dental restoration element is configured to mate with a first convex surface of a dental mounting structure such that there is a dental cement gap between the concave surface and the first convex surface. The dental cement gap is a volume that is defined by the first convex surface and the concave surface.

The dental cement gap is configured to receive the dental cement to cement the dental restoration element to the dental mounting structure. The method comprises receiving the dental restoration element. The method further comprises receiving a cement applicator. The cement applicator comprises a second convex surface. The second convex surface is a transformation of the first convex surface such that it is shrunk by a reduction factor. The method further comprises applying the dental cement to the concave surface. The method further comprises inserting the second convex surface of the cement applicator into the concave surface of the dental restoration element. The method further comprises removing the cement applicator from the dental restoration element to provide the dental restoration element with the applied dental cement.

In another aspect, the invention provides for a dental system that comprises a memory storing machine-executable instructions. The dental system further comprises a computational system. Execution of the machine-executable instructions causes the computational system to receive a digital model of a concave surface of a dental restoration element. The method further comprises receiving one of a digital model of a first convex surface of a dental mounting structure and a digital model of a second convex surface of a cement applicator.

Execution of the machine-executable instructions further causes the computational system to calculate the other of the first convex surface of the dental mounting structure and the digital model of the second convex surface of the cement applicator, such that the second convex surface of the cement applicator is shrunk with respect to the first convex surface by a reduction factor. The concave surface of the dental restoration element is configured to mate with the first convex surface of the dental mounting structure such that there is a dental cement gap between the concave surface and the first convex surface. The dental cement gap is configured to receive the dental cement to cement the digital restoration element to the dental mounting structure. The reduction factor is chosen such that upon applying of the dental cement and removal of the cement applicator, the dental cement remaining is not more than a predetermined amount larger than a volume of the dental cement gap.

In another aspect the invention provides for a computer program that comprises machine-executable instructions for execution by a computational system. Execution of the machine-executable instructions causes the computational system to receive a digital model of a concave surface of a dental restoration element. Execution of the machine-executable instructions further causes the computational system to receive one of a digital model of a first convex surface of a dental mounting structure and a digital model of a second convex surface of a cement applicator.

Execution of the machine-executable instructions further causes the computational system to calculate the other of digital model of the first convex surface of the dental mounting structure and the digital model of the second convex surface of the cement applicator such that the second convex surface of the cement applicator is shrunk with respect to the first convex surface of the dental mounting structure by a reduction factor. The concave surface of the dental restoration element is configured to mate with the first convex surface of the dental mounting structure such that there is a dental cement gap between the concave surface and the first convex surface. The dental cement gap is configured to receive the dental cement to attach the dental restoration element to the dental mounting structure. The reduction factor is chosen such that upon applying of the dental cement and removal of the cement applicator the dental cement remaining on the concave surface is not more than a predetermined amount larger than a volume of the dental cement gap.

### BRIEF DESCRIPTION OF THE DRAWINGS

In the following embodiments of the invention are explained in greater detail, by way of example only, making reference to the drawings in which:

FIG. 1 illustrates an example of an assembled dental restoration.

FIG. 2 shows a flow chart which illustrates a method of applying dental cement to a dental restoration element.

FIG. 3 shows a graphical illustration of applying dental cement to a dental restoration element.

FIG. 4 continues the graphical illustration of FIG. 3.

FIG. 5 shows a further graphical illustration of applying dental cement to a dental restoration element.

FIG. 6 shows a view of a cement applicator loaded with dental cement.

FIG. 7 shows a further view of the second convex surface 302 of the cement applicator 300 after insertion into the concave surface 106 of the dental restoration element 102

FIG. 8 illustrates a mechanical modification to a cement applicator.

FIG. 9 illustrates an example of a dental system.

FIG. 10 shows flow chart which illustrates a method of operating the dental system of FIG. 9.

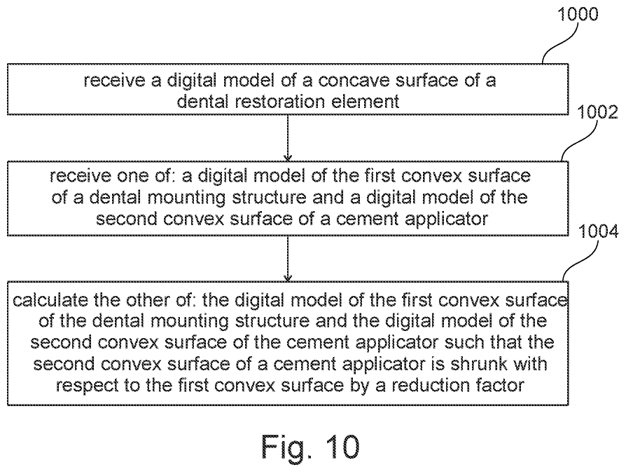

FIG. 11 illustrates a further example of a dental system.

FIG. 12 shows flow chart which illustrates a method of operating the dental system of FIG. 11.

### DETAILED DESCRIPTION

Like numbered elements in these figures are either equivalent elements or perform the same function. Elements which have been discussed previously will not necessarily be discussed in later figures if the function is equivalent.

It should be noted that depending upon the particular example the steps of applying the dental cement to the concave surface and inserting the second convex surface of the cement applicator into the concave surface of the dental restoration element may be interchanged. In some examples, the dental cement is applied before inserting the second convex surface and in other embodiments the cement applicator is used to pump cement through the second convex surface into and onto the concave surface.

Examples may be beneficial because it may provide for an improved means of applying dental cement to the concave surface of a dental restoration element. In current practice dentists apply a large amount of dental cement to a concave surface of the dental restoration element to ensure that there is enough dental cement that is applied. It is then attached to the dental mounting structure in the subject and the excess dental cement is removed. This may for example not be advantageous because amounts of the dental cement may adhere to the gum or under the gum line of the subject. This may result in tooth decay or problems with infections in the subject's gums. The methods may provide a means of applying the appropriate amount of dental cement to the concave surface of a dental restoration element without the need to first place it on the dental mounting structure of the subject.

In another example the method further comprises inserting the first convex surface of the dental mounting structure into the concave surface of the dental restoration element after removing the cement applicator to attach the dental restoration element to the dental mounting structure.

In another example the method further comprises removing adhered dental cement from the cement applicator after removing the cement applicator from the dental restoration element. This may for example be beneficial because the cement applicator may be used to apply the dental cement to the concave surface of a different dental restoration element. This may for example be useful if the first convex surface of the dental mounting structure and the second convex surface of the cement applicator are standardized parts or sizes. Another situation where it may be beneficial to remove the adhered cement is, for example, if the dental cement is cured by light or ultraviolet radiation. This may enable the dental cement to be used again.

In another example the method further comprises storing the adhered dental cement for further use.

In another example the method further comprises manufacturing the cement applicator using the second convex surface. In this case, using the second convex surface for the manufacturing may be considered to manufacture the cement applicator such that at least a portion of the cement applicator comprises a shape which is fit to the second convex surface.

For example, this may include generating rapid prototyping controls or commands for manufacturing at least a portion of the cement applicator such that the rapid prototyping control commands are used to replicate or fabricate the second convex surface. This may also involve using the rapid prototyping control commands to cause a rapid prototyping machine to manufacture the cement applicator such that it has at least a portion of it with the second convex surface.

In another example the cement applicator comprises a dental cement injector. The dental cement injector may for example be a chamber into which dental cement can be packed and then compressed or forced through with a plunger. This may for example be very similar to the structure which is used in a syringe.

In another example the method further comprises manufacturing the cement applicator using a rapid prototyping machine. This may be beneficial because it may provide for a customized cement applicator for a particular dental restoration element.

In another example the rapid prototyping machine is a three-dimensional printer.

In another example the rapid prototyping machine is an automated milling machine.

In another example the rapid prototyping machine is a computer-aided manufacturing machine.

In another example the method further comprises receiving a digital model of a concave surface of a dental restoration element. The method further comprises receiving one of a digital model of the first convex surface of a dental mounting structure and a digital model of a second surface of a cement applicator. In this step either the digital model of the first convex surface or the digital model of the second convex surface is received.

The method further comprises designing the other of the digital model of the first convex surface of the dental mounting structure and the digital model of the second convex surface of the cement applicator such that the second convex surface of the cement applicator is shrunk with respect to the first convex surface by the reduction factor.

There are two different cases in this step. If the digital model of the first convex surface is received, then the digital model of the second convex surface is calculated or designed. If the digital model of the second convex surface of the cement applicator is received, then the digital model of the first convex surface is designed or calculated.

The reduction factor is chosen such that upon applying the dental cement and removal of the cement applicator the dental cement remaining on the concave surface is not more than a predetermined amount larger than a volume of the dental cement gap.

The advantage of this may be that upon removal of the cement applicator the proper amount of dental cement is remaining on the concave surface of the dental restoration element.

In another example the predetermined amount is no more than 50% larger than the volume of the dental cement gap. This may represent a huge improvement over the current practices performed by dentists or dental technicians. Typically, when a dentist installs a dental restoration element such as a crown, the amount of cement may be 100% or even several times the amount of cement actually needed to fill the dental cement gap.

In another example the predetermined amount is no more than 10% larger than the volume of the dental cement gap.

In another example the predetermined amount is no more than 5% larger than the volume of the dental cement gap.

In another example the reduction factor is chosen using a lookup table or a model of adhesion of the dental cement to the cement applicator. The lookup table could for example be performed by performing experiments and noting how much of the dental cement sticks to the cement applicator. In some examples the lookup table and also the model of adhesion may provide for a model of how much of the dental cement remains on a particular surface area of the second convex surface. In other examples, the lookup table and the model of adhesion may contain different entries or results for different types of dental cement.

In another example the method further comprises obtaining the digital model of the first convex surface using an intraoral scanner. An intraoral scanner is an optical device that is placed in the mouth of a subject and used to obtain three-dimensional images of the subject's dental structures.

In another example execution of the machine-executable instructions comprises calculating a dispensed amount of the dental cement which comprises a filling volume defined by the digital model of the concave surface of the dental restoration element and the digital model of the second convex surface of the cement applicator. The filling volume is the volume of dental cement needed to fill the space between the concave surface and the second convex surface.

It should be noted that the dispensed amount may be larger than the filling volume. For example, additional cement may be needed to fill channels or other structures for injecting the dental cement in some. In other examples, additional amounts of dental cement may be added such that there is a slight surplus on the boundary between the dental restoration element and the dental mounting structure.

The method further comprises either displaying the dispensed amount on a display or modifying a design of the cement injector to receive only the dispensed amount of the dental cement. If the dispensed amount is provided on a display then the individual performing the method may use only this dispensed amount when applying the dental cement to the concave surface. This may have the effect of reducing waste.

If the cement injector has its design modified so that it can only receive the dispensed amount of the dental cement, then it provides for a means of automatically reducing the amount of waste dental cement.

In another example the dispensed amount additionally comprises a volume of one or more injection channels of the cement applicator. The injection channels may be configured for delivering the dental cement to the space between the concave surface of the dental restoration element and the second convex surface of the cement applicator.

In another example the dispensed amount further comprises a surplus volume. The surplus volume is up to 50% of the filling volume. In another example the surplus volume is preferably up to 10% of the filling volume. In another example the surplus volume is up to 5% of the filling volume. The filling volume may for example be additional dental cement which is provided such that there is a slight amount of excess, which enables a good seal between the dental restoration element and the dental mounting structure.

In another example the method further comprises filling the cement injector with the dispensed amount for applying the dental cement to the concave surface.

In another example the method further comprises applying the dispensed amount of the dental cement to the concave surface or the second convex surface before inserting the second convex surface into the concave surface. In this example the cement is applied directly to either the concave surface or the second convex surface.

In another example the cement applicator comprises an edge groove configured to increase the spacing between the concave surface and the second convex surface at the entrance region of the concave surface when the second convex surface is installed in the concave surface. This example may be beneficial because it may have the effect of increasing the amount of dental cement available to form an effective seal between the dental restoration element and the dental mounting structure. The effect of having a larger spacing between the concave surface and the second convex surface is that more glue will remain on the concave surface. This provides an additional amount of glue at exactly the exit of the concave surface to the rest of the dental restoration element. This may for example facilitate forming this seal.

In another example the method further comprises applying the dental cement to the concave surface or to the second convex surface of the applicator before inserting the second convex surface of the cement applicator into the concave surface. The method further comprises removal of the excess dental cement using the cement applicator to displace the excess dental cement. In this example the dental cement is applied directly to the concave surface or to the second convex surface and then the concave surface and the second convex surface are pressed together. As they are pressed together the excess dental cement is squeezed out between the two.

In another example the method further comprises removing the excess dental cement after the second convex surface of the cement applicator has been inserted into the concave surface. This example may be beneficial because it may for example provide a means of recycling or reusing the excess dental cement.

In another example the method further comprises storing the excess dental cement for further use.

In another example the cement applicator further comprises at least one cement injection channel. The method further comprises inserting the cement applicator into the concave surface of the restoration element before applying the dental cement to the concave surface. The method further comprises injecting the dental cement through the injection channel to apply the dental cement to the concave surface. This may have the benefit that the amount of cement forced between the cement applicator and the concave surface of the dental restoration element may be precisely controlled.

In an example the at least one cement injection channel is a tube or channel(s) which connect a cement injector or a cement receptacle to the second convex surface of the cement applicator. In either case in some examples, a plunger-like arrangement for example, dental cement forced into a syringe may be used to apply pressure to dental cement to force it through the at least one cement injection channel.

In another example the cement applicator comprises a positioning element configured to hold the second convex surface at a predetermined distance from the concave surface. This may be beneficial because it may provide for a means of ensuring that the cement applicator is not inserted too far or incorrectly into the concave surface of the dental restoration element.

The positioning element(s) could be implemented in several different ways. In one case there may be structures such as a pin-like structure extending from the second convex surface which is configured to touch the concave surface when the second convex surface is precisely inserted. These may serve as spacers. This may have only a minimal effect on the amount of dental cement. In other examples, the positioning element could be outside of the second convex surface and the concave surfaces. For example, the edge of the crown could be configured to touch a surface on the applicator and rest on this to prevent it form being inserted any further. This is another example of a positioning element.

In another example the dental mounting structure is a tooth stump.

In another example the dental mounting structure is a dental tooth preparation.

In another example the dental mounting structure is a dental implant.

In another example the dental mounting structure is a one-piece dental implant.

In another example the dental mounting structure is a dental abutment.

In another example the dental restoration element is a crown.

In another example the dental restoration element is a bridge.

In another example the dental restoration element is an inlay.

In another example the dental restoration element is an onlay.

In another example the dental restoration element is a veneer.

In another example the dental restoration element is a mock-up.

In another example the dental restoration element is a provisional.

In another example the dental restoration element is a wax-up.

In another example the dental restoration element is a bite splint.

In another example the dental restoration element is a dentures.

In another example the dental restoration element is an overdentures.

In another example the dental restoration element is a dental bar.

In another example the dental restoration element is an impression tray.

In another example the dental restoration element is an overlay.

In another example the second convex surface of the cement applicator is a non-stick surface. This may be achieved in several different ways. In some cases, the cement applicator could be manufactured having the second convex surface and then the surface is coated with a non-stick surface, such as Teflon.

A non-stick surface may for example be a material which repels the dental cement. In other examples, when the cement applicator is manufactured, for example using 3D printing, the plastic used for manufacturing the 3D printing could be non-stick or repulsive to the dental cement. A material which repulses the dental cement could for example be included in the mix or master batch used for the plastic for the three-dimensional extrusion.

In another example the second convex surface is modified such that it is porous. Instead of having a flat or smooth surface, the second convex surface may be modified so that it is porous and is able to hold and distribute a larger amount of the dental cement. This may result in better coverage of the concave surface of the dental restoration element.

When the surface is porous, this may result in a change in the calculation for how much cement is needed to fill the space between the second convex surface and the concave surface.

The porous surface could for example be manufactured by adding a roughness to the second convex surface before a 3D printing process.

In another example the predetermined amount is no more than 50% larger than the volume of the dental cement gap.

In another example the predetermined amount is no more than 10% larger than the volume of the dental cement gap.

In another example the predetermined amount is no more than 5% larger than the volume of the dental cement gap.

In another example the reduction factor is chosen using the lookup table or a model of adhesion of dental cement to the cement applicator.

In another example the dental system further comprises an intraoral scanner. Execution of the machine-executable instructions further causes the computational system to obtain the digital model of the first convex surface by controlling the intraoral scanner. This may comprise receiving the digital model of the first convex surface from the intraoral scanner.

In another example execution of the machine-executable instructions further causes the computational system to general rapid prototyping control commands using the second convex surface. The rapid prototyping control commands are configured to cause the rapid prototyping machine to manufacture the cement applicator. The cement applicator will have or comprise the second convex surface.

In another example execution of the machine-executable instructions further causes the computational system to calculate a dispensed amount of the dental cement comprising a filling volume defined by the digital model of the concave surface of the dental restoration element and the digital model of the second convex surface of the cement applicator. The second convex surface and the concave surface are designed not to touch each other. There is an opening in the concave surface where the second convex surface fits into it. It is understood that the volume is closed by connecting the edge of the concave surface with the edge of the second convex surface.

Execution of the machine-executable instructions further causes the computational system to either display the dispensed amount on a display or modify a design of a cement injector configured to receive the dispensed amount of the dental cement.

In another example the dispensed amount additionally comprises a volume of one or more injection channels of the cement applicator.

In another example the dispensed amount further comprises a surplus volume. The surplus volume is up to 50% of the filling volume.

In another example the surplus volume is up to 10% of the filling volume.

In another example the surplus volume is up to 5% of the filling volume.

It is understood that one or more of the aforementioned examples of the invention may be combined as long as the combined examples are not mutually exclusive.

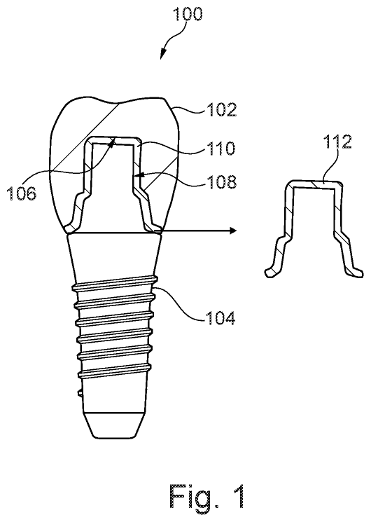

FIG. 1 illustrates an example of an assembled dental restoration 100. The assembled dental restoration 100 comprises a dental restoration element 102, which in this case is a crown, and a dental mounting structure 104. The dental restoration element 102 comprises a concave surface 106 that fits over a first convex surface 108 of the dental mounting structure 104. Between the concave surface 106 and the first convex surface 108 there is a dental cement gap 110. The dental cement gap 110 is a volume which can be filled with dental cement in order to attach the dental restoration element 102 to the dental mounting structure 104. To the right of the assembled dental restoration 100 is a volume of the dental cement gap 112. Both the volume of the dental cement gap 112 can be defined by forming an enclosed surface with the concave surface 106 and then taking the gap between this closed surface and the first convex surface 108 to form the closed surface the edges of the concave surface 106 are connected together.

Currently, when a dental restoration element 102 is mounted on a dental mounting structure 104 a large amount of dental cement 110 is first put in the concave surface 106 and then the concave surface 106 is pushed onto the first convex surface 108. The excess dental cement then flows out between the two and is then later removed by a dentist. A problem with this is this winds up with a large amount of dental cement which needs to be removed and if left in place can result in irritation of the gum or even tooth decay. It is also wasteful in that a large amount of dental cement 110 may be wasted.

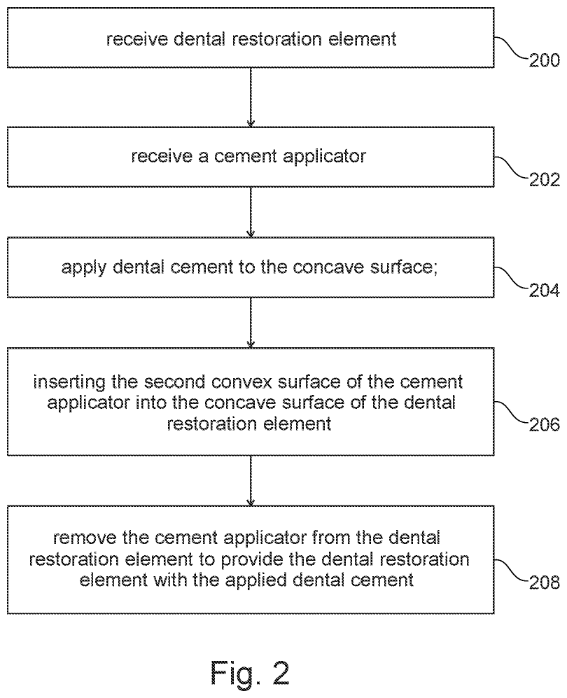

FIG. 2 illustrates a method of applying dental cement to the concave surface 106 of the dental restoration element 102. First, in step 200, the dental restoration element 102 is received. In step 202, a cement applicator is received. In step 204, dental cement is applied to the concave surface. In step 206, the second convex surface of the cement applicator is inserted into the concave surface of the dental restoration element. Then, in step 208, the cement applicator is removed from the dental restoration element 102 to provide the dental restoration element with the applied dental cement.

Depending upon the example, steps 204 and 206 may have their order reversed.

An advantage of using the cement applicator and then removing it is that a precise amount of dental cement may be applied to the concave surface 106 to reduce possibly the amount of waste of dental cement 110 as well as reduce the risk of excess dental cement being left on the subject.

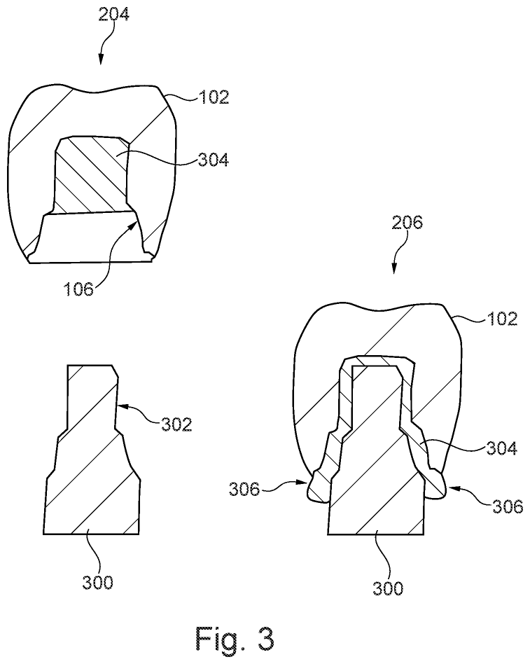

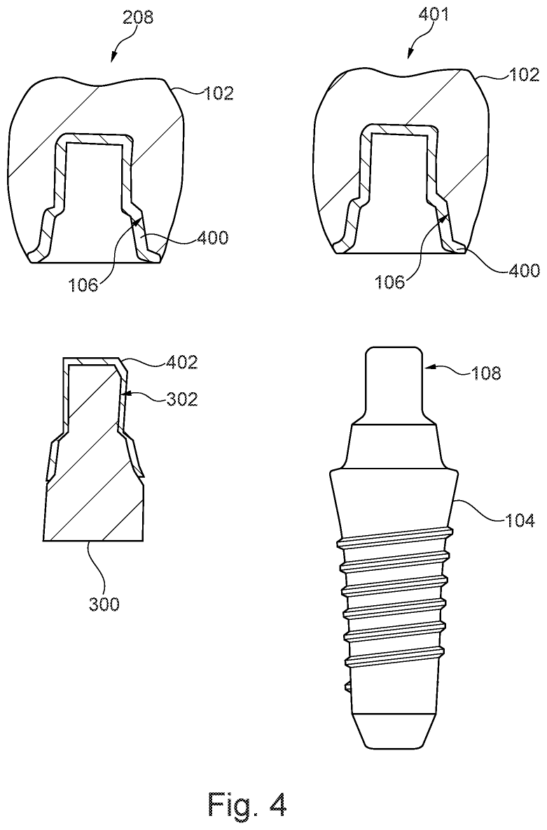

FIGS. 3 and 4 illustrate one example of performing the method illustrated in FIG. 2.

In FIGS. 3 and 4 there are four steps illustrated. The first step illustrated is step 204. In the images for step 204 the dental restoration element 102 is shown as being positioned above a cement applicator 300. The cement applicator 300 has a second convex surface 302. The second convex surface 302 has been formed from the first convex surface 108 by scaling it down and reducing its size. The concave surface 106 has had a dispensed amount of dental cement 304 inserted into it.

In step 206, the second convex surface 302 of the cement applicator 300 has been inserted into the concave surface 106 of the dental restoration element 102. At the base of the dental restoration element 102 it can be seen that there is some excess dental cement 306. By controlling the amount of the dispensed dental cement 304, the excess dental cement 306 can be eliminated or reduced. Often times, it is desirable to have a small amount of excess dental cement 306 so that it can be smoothed to form a good seal between the dental restoration element 102 and the dental mounting structure 104 later.

In FIG. 4, the illustration for step 208 shows the dental restoration element 102 after it has been removed from the cement applicator 300. It can be seen that the concave surface 106 of the dental restoration element 102 has applied dental cement 400 spread across its surface. The cement applicator 300 has an adhered dental cement 402 spread across its second convex surface 302. From this illustration, 208, it can be seen that the dental cement 402 adheres to the surface of the cement applicator 300 such that some of the dental cement is removed from the dental restoration element 102. It is therefore advantageous to have the size of the second convex surface 302 shrunken in respect to the first convex surface 108. The scaling factor for doing this may be determined using an adhesion model of the dental cement 402 or by performing experimentation and retrieving this data via a lookup table later. The types of dental cement may also vary. There may be separate adhesion models and/or lookup tables for different types of dental cement.

In FIG. 4, step 401 shows the dental restoration element 102 with the applied dental cement 400 ready for assembly onto the first convex surface 108 of the dental mounting structure 104. When the concave surface 106 is pressed onto the first convex surface 108 the applied dental cement 400 will adhere the two together and the result will be the assembled dental restoration 100 as is shown in FIG. 1.

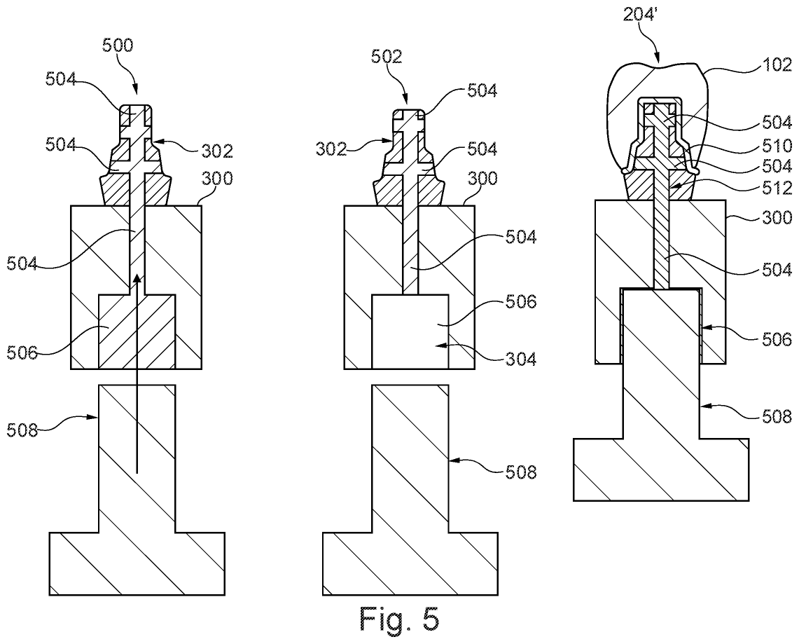

FIG. 5 illustrates an alternative method of performing the steps illustrated in FIG. 2. Illustration 500 shows an empty cement applicator 300. In this example, the cement applicator 300 comprises a cement injector 506 connected via multiple cement injection channels 504 that connect the cement injector 506 with the second convex surface 302. The idea is to fill the cement injector 506 with dental cement and then pressurize it using the plunger 508. This forces the dental cement through the multiple cement injection channels 504 to the space between the concave surface 106 and the second convex surface 302 of the cement applicator 300. Illustration 502 shows a loaded cement applicator 502. The cement injector 506 has been filled with a dispensed amount of dental cement 304. Illustration 204′ shows the injected dental cement. This is after the plunger 508 has been actuated. The plunger 508 has been actuated forcing all of the dispensed amount of dental cement 304 into and through the cement injection channels 504. Before the plunger 508 was depressed, the dental restoration element 102 was mounted on the second convex surface 302. The plunger 508 essentially forced the dental cement into the filling volume 510 between the concave surface 106 of the dental restoration element 102 and the second convex surface 302 of the cement applicator 300.

Looking at illustration 206 it can be seen that the dispensed amount of dental cement 304 may comprise a volume that is the sum of the filling volume 510 as well as a volume 512 of the injection channels. It may also be desirable to add an additional surplus volume of cement to account for cement that adheres to the second convex surface 302 as well as providing a bit of additional dental cement to form a seal between the dental mounting structure 104 and the dental restoration element 102.

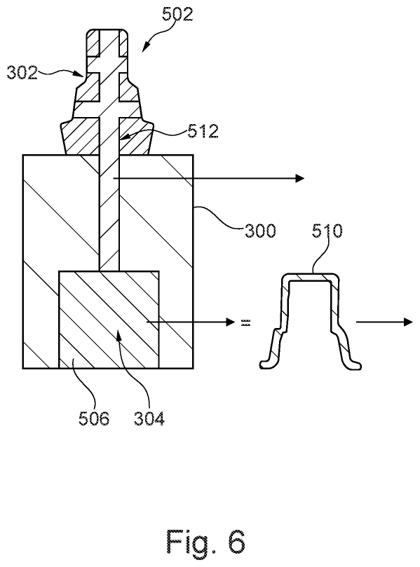

FIG. 6 is a further view of the loaded view of the cement applicator 300. The dispensed amount of dental cement 304 may be a combination of the volume of the cement injection channels 512 plus the filling volume 510.

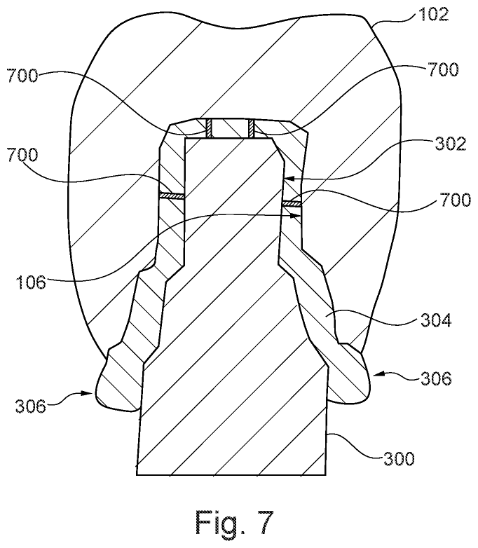

FIG. 7 shows a further view of the second convex surface 302 of the cement applicator 300 after insertion into the concave surface 106 of the dental restoration element 102. This is very similar to the view 206 depicted in FIG. 3. There are additional positioning elements 700 that are attached to the second convex surface 302. The positioning elements 700 may for example be long needle-like structures that provide a spacer between the second convex surface 302 and the concave surface 106. A small number of such positioning elements 700 would effectively prevent the cement applicator 300 from being positioned too deeply into the concave surface 106 as well as possibly preventing an incorrect orientation, depending upon the shapes of the concave surface 106 and the second convex surface 302.

As an alternative to this, the cement applicator 300 may have an abutment which the other surface of the dental restoration element 102 could contact. This could also prevent the second convex surface 302 from being inserted too far into the concave surface 106.

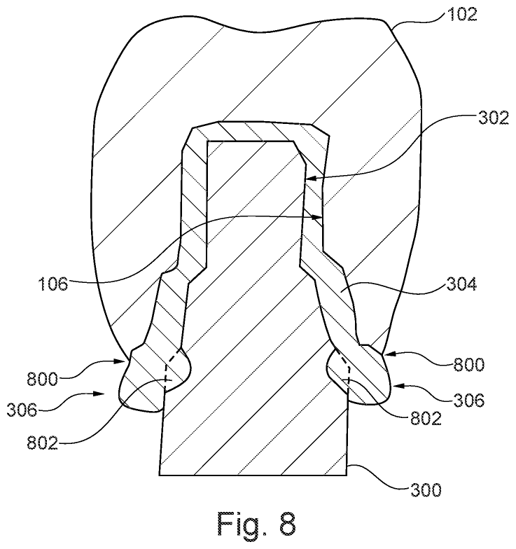

FIG. 8 illustrates a modification to the cement applicator 300. In this example, there is an edge 800 at the edge of the concave surface 106 where it meets an exterior surface of the dental restoration element 102. Adjacent to this, the cement applicator 300 has had an additional edge groove 802 cut into the second convex surface 302. The edge groove 802 may be advantageous because when the cement applicator 300 is removed, it encourages a larger amount of the dental cement 304 to remain near the edge 800 of the concave surface 106. This may enable a metered amount of dental cement to remain near the edge 800 so that it is easier to form an effective seal between the dental restoration element 102 and the dental mounting structure 104.

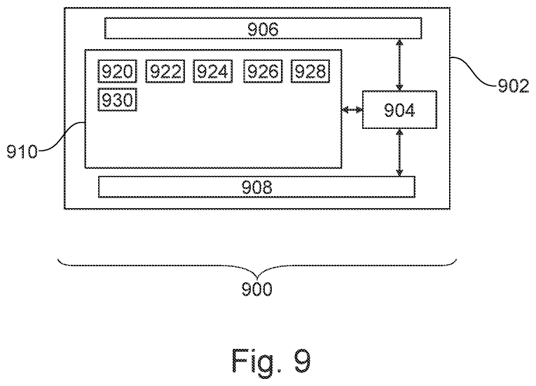

FIG. 9 illustrates an example of a dental system 900. The dental system 900 is shown as comprising a computer 902. The computer 902 may be one or more computers located at one or more locations. The computer 902 is shown as comprising a computational system 904. Likewise, the computational system 904 may represent one or more computing cores and/or computational systems. The computational system 904 is shown as being in communication with an optional hardware interface 906 and an optional user interface 908. The hardware interface 906 may enable the computational system 904 to control other components of the dental system if they are present. The user interface 908 may enable a user to interact with and control the dental system 900.

A memory 910 is also shown as being in communication with the computational system 904. The memory 910 may be representative of any memory which may be in communication with the computational system 904. In some examples, the memory 910 may be or may comprise a non-transitory storage medium. The memory 910 is shown as storing machine-executable instructions 920. The machine-executable instructions 920 enable the computational system 904 to perform such things as numerical and graphic manipulations. The machine-executable instructions 920 may also contain the operating system and other components necessary for the computational system 904 to function within the computer 902.

The memory 910 is further shown as containing a digital model of the concave surface 106 of the dental restoration element 102. The memory 910 is further shown as containing a digital model 924 of the first convex surface 108 of the dental mounting structure 104. The memory 910 is further shown as containing a digital model 926 of the second convex surface 302 of the cement applicator 300.

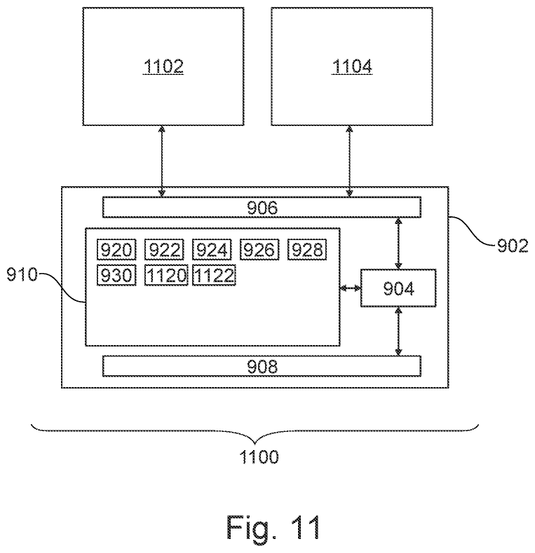

FIG. 11 illustrates a further example of a dental system 1100. The dental system 1100 is similar to the dental system 900 of FIG. 9 except that it additionally comprises an intraoral scanner 1102 and a rapid prototyping machine 1104. In this example, the digital model of the first convex surface 924 is provided by the intraoral scanner 1102. The dental system 1100 would then go through and calculate the digital model of the second convex surface of the cement applicator 926. It would then use the digital model of the second convex surface of the cement applicator 926 to calculate rapid prototyping control commands 1120. The rapid prototyping control commands 1120 are shown as being stored in the memory 910. These may then be sent to the rapid prototyping machine 1104 to automatically manufacture the cement applicator 300. The memory 910 is shown as optionally containing a dispensed amount of the dental cement 1122. This is equivalent to the dispensed amount of dental cement 304 in the earlier Figures. The computational system 904 may for example use the digital model of the second convex surface 926 and the digital model of the concave surface of the dental restoration element 922 to calculate the amount of dental cement needed as well as any additional amounts used as a buffer and also additional amounts of dental cement used to fill any cement injection channels 504.

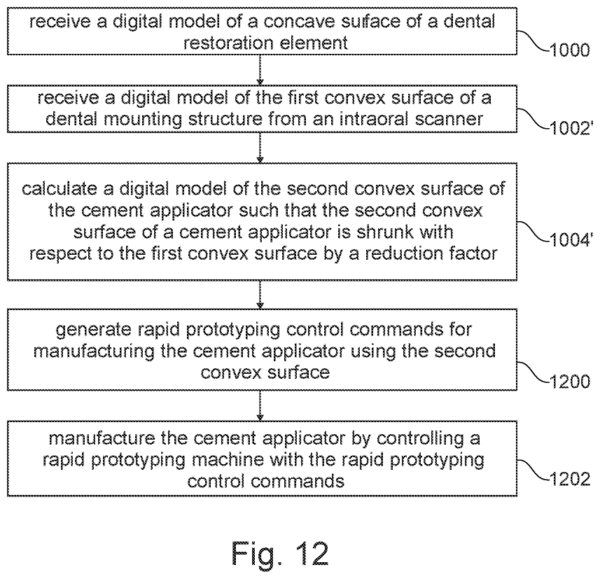

FIG. 12 shows a Figure which illustrates a method of creating the dental system 1100 of FIG. 11. In step 1000 the digital model of the concave surface 922 is received. In step 1002′ the digital model of the first convex surface 924 is received from the intraoral scanner 1102. In step 1004′ the digital model of the second convex surface 926 is calculated such that the second convex surface 926 is shrunk with respect to the first convex surface 924 by the reduction factor 928. In step 1200 the rapid prototyping control commands 1120 are generated for manufacturing the cement applicator 300 using the second convex surface 926. Then, in step 1202, the cement applicator 300 is manufactured by controlling the rapid prototyping machine 1104 with the rapid prototyping control commands 1120.

As will be appreciated by one skilled in the art, aspects of the present invention may be embodied as an apparatus, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer executable code embodied thereon.

Any combination of one or more computer readable medium(s) may be utilized. The computer readable medium may be a computer readable signal medium or a computer readable storage medium. A ‘computer-readable storage medium’ as used herein encompasses any tangible storage medium which may store instructions which are executable by a processor or computational system of a computing device. The computer-readable storage medium may be referred to as a computer-readable non-transitory storage medium. The computer-readable storage medium may also be referred to as a tangible computer readable medium. In some embodiments, a computer-readable storage medium may also be able to store data which is able to be accessed by the computational system of the computing device. Examples of computer-readable storage media include, but are not limited to: a floppy disk, a magnetic hard disk drive, a solid state hard disk, flash memory, a USB thumb drive, Random Access Memory (RAM), Read Only Memory (ROM), an optical disk, a magneto-optical disk, and the register file of the computational system. Examples of optical disks include Compact Disks (CD) and Digital Versatile Disks (DVD), for example CD-ROM, CD-RW, CD-R, DVD-ROM, DVD-RW, or DVD-R disks. The term computer readable-storage medium also refers to various types of recording media capable of being accessed by the computer device via a network or communication link. For example, data may be retrieved over a modem, over the internet, or over a local area network. Computer executable code embodied on a computer readable medium may be transmitted using any appropriate medium, including but not limited to wireless, wire line, optical fiber cable, RF, etc., or any suitable combination of the foregoing.

A computer readable signal medium may include a propagated data signal with computer executable code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

‘Computer memory’ or ‘memory’ is an example of a computer-readable storage medium. Computer memory is any memory which is directly accessible to a computational system. ‘Computer storage’ or ‘storage’ is a further example of a computer-readable storage medium. Computer storage is any non-volatile computer-readable storage medium. In some embodiments computer storage may also be computer memory or vice versa.

A ‘computational system’ as used herein encompasses an electronic component which is able to execute a program or machine executable instruction or computer executable code. References to the computational system comprising the example of “a computational system” should be interpreted as possibly containing more than one computational system or processing core. The computational system may for instance be a multi-core processor. A computational system may also refer to a collection of computational systems within a single computer system or distributed amongst multiple computer systems. The term computational system should also be interpreted to possibly refer to a collection or network of computing devices each comprising a processor or computational systems. The machine executable code or instructions may be executed by multiple computational systems or processors that may be within the same computing device or which may even be distributed across multiple computing devices.

Machine executable instructions or computer executable code may comprise instructions or a program which causes a processor or other computational system to perform an aspect of the present invention. Computer executable code for carrying out operations for aspects of the present invention may be written in any combination of one or more programming languages, including an object-oriented programming language such as Java, Smalltalk, C++ or the like and conventional procedural programming languages, such as the “C” programming language or similar programming languages and compiled into machine executable instructions. In some instances, the computer executable code may be in the form of a high-level language or in a pre-compiled form and be used in conjunction with an interpreter which generates the machine executable instructions on the fly. In other instances, the machine executable instructions or computer executable code may be in the form of programming for programmable logic gate arrays.

The computer executable code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It is understood that each block or a portion of the blocks of the flowchart, illustrations, and/or block diagrams, can be implemented by computer program instructions in form of computer executable code when applicable. It is further under stood that, when not mutually exclusive, combinations of blocks in different flowcharts, illustrations, and/or block diagrams may be combined. These computer program instructions may be provided to a computational system of a general-purpose computer, special purpose computer, or other programmable data processing apparatus to produce a machine, such that the instructions, which execute via the computational system of the computer or other programmable data processing apparatus, create means for implementing the functions/acts specified in the flowchart and/or block diagram block or blocks.

These machine executable instructions or computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The machine executable instructions or computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

A ‘user interface’ as used herein is an interface which allows a user or operator to interact with a computer or computer system. A ‘user interface’ may also be referred to as a ‘human interface device.’ A user interface may provide information or data to the operator and/or receive information or data from the operator. A user interface may enable input from an operator to be received by the computer and may provide output to the user from the computer. In other words, the user interface may allow an operator to control or manipulate a computer and the interface may allow the computer to indicate the effects of the operator's control or manipulation. The display of data or information on a display or a graphical user interface is an example of providing information to an operator. The receiving of data through a keyboard, mouse, trackball, touchpad, pointing stick, graphics tablet, joystick, gamepad, webcam, headset, pedals, wired glove, remote control, and accelerometer are all examples of user interface components which enable the receiving of information or data from an operator.

A ‘hardware interface’ as used herein encompasses an interface which enables the computational system of a computer system to interact with and/or control an external computing device and/or apparatus. A hardware interface may allow a computational system to send control signals or instructions to an external computing device and/or apparatus. A hardware interface may also enable a computational system to exchange data with an external computing device and/or apparatus. Examples of a hardware interface include, but are not limited to: a universal serial bus, IEEE 1394 port, parallel port, IEEE 1284 port, serial port, RS-232 port, IEEE-488 port, Bluetooth connection, Wireless local area network connection, TCP/IP connection, Ethernet connection, control voltage interface, MIDI interface, analog input interface, and digital input interface.

A ‘display’ or ‘display device’ as used herein encompasses an output device or a user interface adapted for displaying images or data. A display may output visual, audio, and or tactile data. Examples of a display include, but are not limited to: a computer monitor, a television screen, a touch screen, tactile electronic display, Braille screen, Cathode ray tube (CRT), Storage tube, Bi-stable display, Electronic paper, Vector display, Flat panel display, Vacuum fluorescent display (VF), Light-emitting diode (LED) displays, Electroluminescent display (ELD), Plasma display panels (PDP), Liquid crystal display (LCD), Organic light-emitting diode displays (OLED), a projector, and Head-mounted display.

Although the invention has been described in reference to specific embodiments, it should be understood that the invention is not limited to these examples only and that many variations of these embodiments may be readily envisioned by the skilled person after having read the present disclosure. The invention may thus further be described without limitation and by way of example only by the following embodiments. The following embodiments may contain preferred embodiments. Accordingly, the term “clause” as used therein may refer to such a “preferred embodiment”.

Clause 1. A method of applying dental cement to a concave surface of a dental restoration element, wherein the concave surface of the dental restoration element is configured to mate with a first convex surface of a dental mounting structure such that there is a dental cement gap between the concave surface and the first convex surface, wherein the dental cement gap is configured to receive the dental cement to cement the dental restoration element to the dental mounting structure, wherein the method comprises:
receiving the dental restoration element;
receiving a cement applicator, wherein the cement applicator comprises a second convex surface, wherein the second convex surface is a transformation of the first convex surface such that it is shrunk by a reduction factor;
applying the dental cement to the concave surface;
inserting the second convex surface of the cement applicator into the concave surface of the dental restoration element; and
removing the cement applicator from the dental restoration element to provide the dental restoration element with the applied dental cement.

Clause 2. The method of clause 1, wherein the method further comprises inserting the first convex surface of the dental mounting structure into the concave surface of the dental restoration element after removing the cement applicator to attach the dental restoration element to the dental mounting structure.

Clause 3. The method of clause 1 or 2, wherein the method further comprises removing adhered dental cement from the cement applicator after removing the cement applicator from the dental restoration element.

Clause 4. The method of clause 3, wherein the method further comprises storing the adhered dental cement for further use.

Clause 5. The method of any one of the preceding clauses, wherein the method further comprises manufacturing the cement applicator using the second convex surface.

Clause 6. The method of clause 5, wherein the cement applicator comprises a dental cement injector.

Clause 7. The method of clause 5 or 6, wherein the method further comprises manufacturing the cement applicator using a rapid prototyping machine.

Clause 8. The method of clause 6, wherein the rapid prototyping machine is any one of the following: a three-dimensional printer, an automated milling machine, a CAM manufacturing machine, and combinations thereof.

Clause 9. The method of any one of clauses 5 through 8, wherein the method further comprises:
receiving a digital model of the concave surface of the dental restoration element;
receiving one of: a digital model of the first convex surface of the dental mounting structure and a digital model of the second convex surface of the cement applicator;
designing the other of: the digital model of the first convex surface of the dental mounting structure and the digital model of the second convex surface of the cement applicator such that the second convex surface of the cement applicator is shrunk with respect to the first convex surface by the reduction factor,

Clause 10. The method of clause 9, wherein the reduction factor is chosen such that upon the applying of the dental cement and removal of the cement applicator the dental cement remaining on the concave surface is not more than a predetermined amount larger than a volume of the dental cement gap.

Clause 11. The method of clause 10, wherein the predetermined amount larger is no more than 50% larger than the volume of the dental cement gap, wherein the predetermined amount larger is preferably no more than 10% larger than the volume of the dental cement gap, and wherein the predetermined amount is no more than 5% larger than the volume of the dental cement gap.

Clause 12. The method of clause 9, 10, or 11, wherein the reduction factor is chosen using a lookup table or a model of adhesion of dental cement to the cement applicator.

Clause 13. The method of any one of clauses 9 through 12, wherein the method further comprises obtaining the digital model of the first convex surface using an intraoral scanner.

Clause 14. The method of any one of clauses 9 through 13, wherein the method further comprises:
calculating a dispensed amount of the dental cement comprising a filling volume defined by the digital model of the concave surface of the dental restoration element and the digital model of the second convex surface of the cement applicator; and
any one of the following: displaying the dispensed amount on a display or modifying a design of a cement injector to receive the dispensed amount of the dental cement.

Clause 15. The method of clause 14, wherein the dispensed amount additionally comprises a volume of one or more injection channels of the cement applicator.

Clause 16. The method of clause 14 or 15, wherein the dispensed amount further comprises a surplus volume, wherein the surplus volume is up to 50% of the filing volume.

Clause 17. The method of clause 14 or 15, wherein the dispensed amount further comprises a surplus volume, wherein the surplus volume is up to 10% of the filling volume.

Clause 18. The method of clause 14 or 15, wherein the dispensed amount further comprises a surplus volume, wherein the surplus volume is up to 5% of the filing volume.

Clause 19. The dental system of any one of clauses 14 through 18, wherein the method further comprises filling the cement injector with the dispensed amount for applying the dental cement to the concave surface.

Clause 20. The dental system of any one of clauses 14 through 18, wherein the method further comprises applying the dispensed amount of the dental cement to the concave surface or the second convex surface before inserting the second convex surface into the concave surface.

Clause 21. The method of any one of the preceding clauses, wherein the cement applicator comprises an edge groove configured to increase a spacing between the concave surface and the second convex surface at an entrance region of the concave surface when the second convex surface is installed in the concave surface.

Clause 22. The method of any one of the preceding clauses, wherein the method further comprises applying the dental cement to the concave surface or to the second convex surface of the applicator before inserting the second convex surface of the cement applicator into the concave surface, wherein the method further comprises removal of excess dental cement using the cement applicator to displace the excess dental cement.

Clause 23. The method of clause 22, wherein the method further comprises removing the excess dental cement when the second convex surface of the cement applicator is inserted into the concave surface.

Clause 24. The method of clause 23, wherein the method further comprises storing the excess dental cement for further use.

Clause 25. The method of any one of clauses 1 through 21, wherein the cement applicator further comprises a at least one cement injection channel, wherein the method further comprises:
inserting the cement applicator into the concave surface of the restoration element before applying the dental cement to the concave surface; and
injecting the dental cement through the injection channel to apply the dental cement to the concave surface.

Clause 26. The method of any one of the preceding clauses, wherein the cement applicator comprises a positioning element configured to hold the second convex surface at a predetermined distance from the concave surface.

Clause 27. The method of any one of the preceding clauses, wherein the dental mounting structure is any one of the following: a tooth stump, a dental tooth preparation, a dental implant, a one-piece dental implant, and a dental abutment.

Clause 28. The method of any one of the preceding clauses, wherein the dental restoration element is any one of the following: a crown, a bridge, an inlay, an onlay, veneer, mock up, provisional, waxup, bitesplint, dentures, over dentures, dental bar, impression tray, and an overlay.

Clause 29. The method of any one of the preceding clauses, wherein the second convex surface is a non-stick surface.

Clause 30. The method of any one of clauses 1 through 28, wherein the second convex surface is modified such that it is porous.

Clause 31. The method of any one of the preceding clauses, with the proviso that the method excludes a method for treatment of the human or animal body by surgery or therapy.

Clause 32. A dental system comprising:
a memory storing machine executable instructions; and
a computational system, wherein execution of the machine executable instructions causes the computational system to:
   receive (1000) a digital model of a concave surface of a dental restoration element;
   receiving (1002) one of: a digital model of the first convex surface of a dental mounting structure and a digital model of the second convex surface of a cement applicator; and
   calculate (1004) the other of: the digital model of the first convex surface of the dental mounting structure and the digital model of the second convex surface of the cement applicator such that the second convex surface of a cement applicator is shrunk with respect to the first convex surface by a reduction factor,

Clause 33. The dental system of clause 32, wherein the concave surface of the dental restoration element is configured to mate with the first convex surface of the dental mounting structure such that there is a dental cement gap between the concave surface and the first convex surface, wherein the dental cement gap is configured to receive the dental cement to cement the dental restoration element to the dental mounting structure.

Clause 34. The dental system of clause 33, wherein the reduction factor is chosen such that upon applying of the dental cement and removal of the cement applicator the dental cement remaining on the concave surface is not more than a predetermined amount larger than a volume of the dental cement gap.

Clause 35. The dental system of clause 34, wherein the predetermined amount larger is no more than 50% larger than the volume of the dental cement gap, wherein the predetermined amount larger is preferably no more than 10% larger than the volume of the dental cement gap, and wherein the predetermined amount is no more than 5% larger than the volume of the dental cement gap.

Clause 36. The dental system of any one of clauses 32 through 35, wherein the reduction factor is chosen using a lookup table or a model of adhesion of dental cement to the cement applicator.

Clause 37. The dental system of any one of clauses 32 through 36, wherein the dental system further comprises an intraoral scanner, wherein execution of the machine executable instructions further causes the computational system to obtain the digital model of the first convex surface by controlling an intraoral scanner.

Clause 38. The dental system of any one of clauses 32 through 37, wherein execution of the machine executable instructions further causes the computational system to generate rapid prototyping control commands using the second convex surface, wherein the rapid prototyping control configured to cause a rapid prototyping machine to manufacture the cement applicator.

Clause 39. The dental system of any one of clauses 32 through 38, wherein execution of the machine executable instructions further causes the computational system to:
calculate a dispensed amount of the dental cement comprising a filling volume defined by the digital model of the concave surface of the dental restoration element and the digital model of the second convex surface of the cement applicator; and
any one of the following: display the dispense amount on a display or modify a design of a cement injector of the cement applicator to receive the dispense amount of the dental cement.

Clause 40. The dental system of clause 39, wherein the dispensed amount additionally comprises a volume of one or more injection channels of the cement applicator.

Clause 41. The dental system of clause 39 or 40, wherein the dispensed amount further comprises a surplus volume, wherein the surplus volume is up to 50% of the filing volume.

Clause 42. The dental system of clause 39 or 40, wherein the dispensed amount further comprises a surplus volume, wherein the surplus volume is up to 10% of the filing volume.

Clause 43. The dental system of clause 39 or 40, wherein the dispensed amount further comprises a surplus volume, wherein the surplus volume is up to 5% of the filing volume.

Clause 44. A computer program comprising machine executable instructions for execution by a computational system, wherein execution of the machine executable instructions causes the computational system to:
receive a digital model of a concave surface of a dental restoration element;
receive one of: a digital model of a first convex surface of a dental mounting structure and a digital model of a second convex surface of a cement applicator; and
calculate the other of: the digital model of the first convex surface of the dental mounting structure and the digital model of the second convex surface of the cement applicator such that the second convex surface of a cement applicator is shrunk with respect to the first convex surface by a reduction factor.

Clause 45. The computer program of claim 44, wherein the concave surface of the dental restoration element is configured to mate with the first convex surface of the dental mounting structure such that there is a dental cement gap between the concave surface and the first convex surface, wherein the dental cement gap is configured to receive the dental cement to attach the dental restoration element to the dental mounting structure.

Clause 46. The computer program of clause 45, wherein the reduction factor is chosen such that upon applying of the dental cement and removal of the cement applicator the dental cement remaining on the concave surface is not more than a predetermined amount larger than a volume of the dental cement gap.

### LIST OF REFERENCE NUMERALS

100 assembled dental restoration
102 dental restoration element
104 dental mounting structure
106 concave surface
108 first convex surface
110 dental cement gap
112 volume of dental cement gap
200 receive dental restoration element
202 receive a cement applicator
204 apply dental cement to the concave surface
204′ injecting dental cement
206 inserting the second convex surface of the cement applicator into the concave surface of the dental restoration element
208 remove the cement applicator from the dental restoration element to provide the dental restoration element with the applied dental cement
300 cement applicator
302 second convex surface
304 dispensed amount of dental cement
306 excess dental cement
400 applied dental cement
401 provide prepared dental restoration element
402 adhered dental cement
500 empty cement applicator
502 loaded cement applicator
504 cement injection channel
506 cement injector
508 plunger
510 filling volume
512 volume of cement injection channels surplus volume
700 positioning element
800 edge of concave surface
800 edge groove
900 dental system
902 computer
904 computational system
906 optional hardware interface
908 optional user interface
910 memory
920 machine executable instructions
922 digital model of concave surface of dental restoration element
924 digital model of first convex surface of dental mounting structure
926 digital model of second convex surface of cement applicator
928 reduction factor
930 lookup table
1000 receive a digital model of a concave surface of a dental restoration element
1002 receive one of: a digital model of the first convex surface of a dental mounting structure and a digital model of the second convex surface of a cement applicator
1002′ receive a digital model of the first convex surface of a dental mounting structure from an intraoral scanner
1004 calculate the other of: the digital model of the first convex surface of the dental mounting structure and the digital model of the second convex surface of the cement applicator such that the second convex surface of a cement applicator is shrunk with respect to the first convex surface by a reduction factor
1004′ calculate a digital model of the second convex surface of the cement applicator such that the second convex surface of a cement applicator is shrunk with respect to the first convex surface by a reduction factor
1100 dental system
1102 intraoral scanner
1104 rapid prototyping machine
1120 rapid prototyping control commands
1122 dispense amount of dental cement
1200 generate rapid prototyping control commands for manufacturing the cement applicator using the second convex surface
1202 manufacture the cement applicator by controlling a rapid prototyping machine with the rapid prototyping control commands

What is claimed is:

1. A method of applying dental cement to a concave surface of a dental restoration element, wherein the concave surface of the dental restoration element is configured to mate with a first convex surface of a dental mounting structure such that there is a dental cement gap between the concave surface and the first convex surface, wherein the dental cement gap is configured to receive the dental cement to cement the dental restoration element to the dental mounting structure, wherein the method comprises:
receiving the dental restoration element;
receiving a cement applicator, wherein the cement applicator comprises a second convex surface, wherein the second convex surface is a transformation of the first convex surface such that it is shrunk by a reduction factor;
applying the dental cement to the concave surface;
inserting the second convex surface of the cement applicator into the concave surface of the dental restoration element; and
removing the cement applicator from the dental restoration element to provide the dental restoration element with the applied dental cement.

2. The method of claim 1, wherein the method further comprises inserting the first convex surface of the dental mounting structure into the concave surface of the dental restoration element after removing the cement applicator to attach the dental restoration element to the dental mounting structure.

3. The method of claim 1 or 2, wherein the method further comprises manufacturing the cement applicator using the second convex surface.

4. The method of claim 3, wherein the method further comprises manufacturing the cement applicator using a rapid prototyping machine.

5. The method of claim 3 or 4, wherein the method further comprises:
receiving a digital model of the concave surface of the dental restoration element;
receiving one of: a digital model of the first convex surface of the dental mounting structure and a digital model of the second convex surface of the cement applicator;
design the other of: the digital model of the first convex surface of the dental mounting structure and the digital model of the second convex surface of the cement applicator such that the second convex surface of the cement applicator is shrunk with respect to the first convex surface by the reduction factor, wherein the reduction factor is chosen such that upon the applying of the dental cement and removal of the cement applicator the dental cement remaining on the concave surface is not more than a predetermined amount larger than a volume of the dental cement gap.

6. The method of any one of claim 5, wherein the method further comprises obtaining the digital model of the first convex surface using an intraoral scanner.

7. The method of any one of claim 5 or 6, wherein the method further comprises:
calculating a dispensed amount of the dental cement comprising a filling volume defined by the digital model of the concave surface of the dental restoration element and the digital model of the second convex surface of the cement applicator; and
any one of the following: displaying the dispensed amount on a display or modifying a design of a cement injector to receive the dispensed amount of the dental cement.

8. The method of any one of the preceding claims, wherein the cement applicator comprises an edge groove configured to increase a spacing between the concave surface and the second convex surface at an entrance region of the concave surface when the second convex surface is installed in the concave surface.

9. The method of any one of the preceding claims, wherein the method further comprises applying the dental cement to the concave surface or to the second convex surface of the applicator before inserting the second convex surface of the cement applicator into the concave surface, wherein the method further comprises removal of excess dental cement using the cement applicator to displace the excess dental cement.

10. The method of any one of claims 1 through 8, wherein the cement applicator further comprises a at least one cement injection channel, wherein the method further comprises:
inserting the cement applicator into the concave surface of the restoration element before applying the dental cement to the concave surface; and
injecting the dental cement through the injection channel to apply the dental cement to the concave surface.

11. The method of any one of the preceding claims, wherein the cement applicator comprises a positioning element configured to hold the second convex surface at a predetermined distance from the concave surface.

12. The method of any one of the preceding claims, wherein the second convex surface is a non-stick surface.

13. The method of any one of claims 1 through 11, wherein the second convex surface is modified such that it is porous.

14. A dental system comprising:
a memory storing machine executable instructions; and
a computational system, wherein execution of the machine executable instructions causes the computational system to:
receive a digital model of a concave surface of a dental restoration element;
receive one of: a digital model of the first convex surface of a dental mounting structure and a digital model of the second convex surface of a cement applicator; and
calculate the other of: the digital model of the first convex surface of the dental mounting structure and the digital model of the second convex surface of the cement applicator such that the second convex surface of a cement applicator is shrunk with respect to the first convex surface by a reduction factor, wherein the concave surface of the dental restoration element is configured to mate with the first convex surface of the dental mounting structure such that there is a dental cement gap between the concave surface and the first convex surface, wherein the dental cement gap is configured to receive the dental cement to cement the dental restoration element to the dental mounting structure, wherein the reduction factor is chosen such that upon applying of the dental cement and removal of the cement applicator the dental cement remaining on the concave surface is not more than a predetermined amount larger than a volume of the dental cement gap.

15. The dental system of claim 14, wherein the predetermined amount larger is no more than 50% larger than the volume of the dental cement gap, wherein the predetermined amount larger is preferably no more than 10% larger than the volume of the dental cement gap, and wherein the predetermined amount is no more than 5% larger than the volume of the dental cement gap.

16. The dental system of claim 14 or 15, wherein the dental system further comprises an intraoral scanner, wherein execution of the machine executable instructions further causes the computational system to obtain the digital model of the first convex surface by controlling an intraoral scanner.

17. The dental system of claim 14, 15, or 16, wherein execution of the machine executable instructions further causes the computational system to generate rapid prototyping control commands using the second convex surface, wherein the rapid prototyping control configured to cause a rapid prototyping machine to manufacture the cement applicator.

18. The dental system of any one of claims 14 through 17, wherein execution of the machine executable instructions further causes the computational system to:
calculate a dispensed amount of the dental cement comprising a filling volume defined by the digital model of the concave surface of the dental restoration element and the digital model of the second convex surface of the cement applicator; and
any one of the following: display the dispense amount on a display or modify a design of a cement injector of the cement applicator to receive the dispense amount of the dental cement.

19. The dental system of claim 18, wherein the dispensed amount additionally comprises a volume of one or more injection channels of the cement applicator, wherein the dispensed amount further comprises a surplus volume, wherein the surplus volume is up to 50% of the filing volume, wherein the surplus volume is preferably up to 10% of the filing volume, wherein the surplus volume is up to 5% of the filing volume.

20. A computer program comprising machine executable instructions for execution by a computational system, wherein execution of the machine executable instructions causes the computational system to:
receive a digital model of a concave surface of a dental restoration element;
receive one of: a digital model of a first convex surface of a dental mounting structure and a digital model of a second convex surface of a cement applicator; and
calculate the other of: the digital model of the first convex surface of the dental mounting structure and the digital model of the second convex surface of the cement applicator such that the second convex surface of a cement applicator is shrunk with respect to the first convex surface by a reduction factor, wherein the concave surface of the dental restoration element is configured to mate with the first convex surface of the dental mounting structure such that there is a dental cement gap between the concave surface and the first convex surface, wherein the dental cement gap is configured to receive the dental cement to attach the dental restoration element to the dental mounting structure, wherein the reduction factor is chosen such that upon applying of the dental cement and removal of the cement applicator the dental cement remaining on the concave surface is not more than a predetermined amount larger than a volume of the dental cement gap.
